(19) United States
(12) Patent Application Publication
(10) Pub. No.: US 2013/0174914 A1
(43) Pub. Date: Jul. 11, 2013

(54) Magnetically Activated Safety Valve Sealable Upon Rupturing

(71) Applicants: Michael McAvey, Ridgewood, NJ (US); Raymond Bartko, Carmel, NY (US); John Lonczak, Newburgh, NY (US)

(72) Inventors: Michael McAvey, Ridgewood, NJ (US); Raymond Bartko, Carmel, NY (US); John Lonczak, Newburgh, NY (US)

(21) Appl. No.: 13/702,741

(22) PCT Filed: Jun. 7, 2011
(86) PCT No.: PCT/US11/39383

§ 371 Date: Mar. 27, 2013

Related U.S. Application Data
(60) Provisional application No. 61/351,980, filed on Jun. 7, 2010.

(51) Int. Cl. F16K 17/40

(52) U.S. Cl. CPC F16K 17/40
USPC 137/2; 137/68.11

(57) ABSTRACT

A safety valve designed to stop the flow of fluid through a conduit or pipe when an internal or external force causes the valve to rupture in a predetermined region and a method for using such a safety valve is provided. The safety valve generally comprises a first region, a second region, and a separation region. The separation region is designed such that the application of an internal or external force or force will cause the valve to rupture.

### FIELD

This disclosure relates generally to safety valves used to control the flow of fluids through a conduit or pipe. More specifically, this disclosure relates to safety valves designed to stop the flow of fluid upon the separation or rupturing of the valve.

### BACKGROUND

The transfer of a fluid from a reservoir to a receiver through a conduit or pipeline is a routine occurrence in many applications. Typically, such a transfer includes a conventional safety device, such as an on-off valve capable of controlling the flow of fluid through the conduit. However, such conventional safety valves typically are not usually capable of stopping the flow of fluid when the conduit or pipeline is ruptured.

U.S. Pat. No. 6,591,864 relates to a pressure release valve for use on fuel tanker trucks which can rollover in an accident. There is a requirement for such valves to become sealed in the event of a rollover to prevent the escape of volatile and flammable fluid from within the tanker. The valve comprises a movable plunger and a fixed seat which can move axially towards and away from each other to open and close the valve. One of the valve seat and plunger is provided with magnetic inserts, while the alternate component is ferromagnetic so that magnetic attraction between the two components act to bias the valve towards a closed condition.

Accordingly, there is a continual need or desire to provide an improved method or system including a safety valve that enhances the safety of transferring fluid from a reservoir to a receiver when an internal or external force or event causes the connection between the reservoir and receiver to rupture.

### SUMMARY

In satisfying the above need, as well as overcoming the enumerated drawbacks and other limitations of the related art, the present disclosure provides a safety valve designed to stop the flow of fluid through a conduit or pipe when an internal or external force causes the valve to rupture in a predetermined region. The safety valve generally comprises a valve body forming a channel through which the fluid may flow.

According to one aspect of the present disclosure, the valve body comprises a first region, a second region, and a separation region. The first region includes a first magnet having a passageway that is part of the channel. The second region includes a second magnet that is sized to fit into the channel and to allow fluid to flow around its periphery. The second region also includes a spring in contact with the second magnet and the valve body; and an annular seat that is part of the channel and sized to mate with the second magnet. The separation region is designed such that the valve body will rupture in this region upon the application of the internal or external force. The first magnet and the second magnet are positioned so that their poles interact with one another to create a magnetic force having a magnitude that causes the spring to move either in compression or extension, thereby, allowing fluid to freely flow through the channel from the second region to the first region. When the valve ruptures in the predetermined separation region, the magnetic force between the magnets is reduced to allow the spring to cause the second magnet to mate with the seat, thereby, stopping the flow of fluid through the channel. Preferably, the magnets are arranged such that the magnetic force is one of magnetic repulsion.

According to another aspect of the present disclosure, the first or second magnet may be coated with a material capable of protecting the magnet from the effects of the fluid flowing through the valve. The Currie point at which at least one of the first and second magnets partially loses its magnetism is about 150° C.

The valve body may be made from any material known to one skilled in the art including, but not limited to aluminum, brass, stainless steel, ceramics, and a thermoplastic resin. Preferably, the separation region of the valve body is at least partially made from a material that is different than the material used to make the first and second regions of the valve body. This difference in materials between the separation region and the first and second regions can be used to allow the separation region to rupture upon the occurrence of an external or internal force. The external or internal force that causes the separation region to rupture may be a shearing force, a stretching force, a compressive force, a thermal change, or chemical attack or degradation.

According to another aspect of the present disclosure, a method is provided to stop the flow of fluid through a conduit or pipe when an internal or external force causes the conduit or pipe to rupture in a predetermined region. The method comprises the steps of causing fluid to flow through a pipe or conduit, wherein the pipe or conduit is adapted to include the safety valve described above and herein; applying an external force to the safety valve; rupturing the safety valve in the predetermined separation region; allowing the spring in the safety valve to force the second magnet to mate with the seat in the valve; and causing the flow of fluid through the conduit or pipe to stop.

The method of the stopping of the flow of fluid through a conduit or pipe when an internal or external force causes the conduit or pipe to rupture in the predetermined region may also comprise the steps of causing fluid to flow through a pipe or conduit, the pipe or conduit including the safety valve; applying an external force to the safety valve; rupturing the safety valve in the predetermined separation region; allowing the first and second springs in the safety valve to force the first or second magnets to mate with the first or second seats in the valve; and causing the flow of fluid through the conduit or pipe to stop.

The fluid flowing through the pipe or conduit may be a non-hazardous liquid or gas, such as water or air, as well as any flammable, toxic, corrosive, and/or combustible gas or liquid. The fluid may be a fuel used to operate a combustion engine.

According to another aspect of the present disclosure, a system for transferring a fluid provided with a safety mechanism that will stop the flow of fluid through the system when an internal or external force causes a predetermined region in the system to rupture is provided. This system generally comprises a fluid supply reservoir or line; a fluid receiver; a pipe or conduit through which fluid flows from the fluid supply reservoir or line to the fluid receiver; and a safety valve coupled to the pipe or conduit so that fluid flows through the safety valve. The safety valve used in the system includes a region predetermined to rupture upon the application of the internal or external force. When the internal or external force causes the safety valve to rupture, the fluid flowing through the pipe from the reservoir to the receiver is stopped.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is perspective view of a valve prepared according to the teaching of one embodiment of the present disclosure;

FIG. 1B is a cross-sectional view along plane A-A of the valve from FIG. 1A according to one aspect of the present disclosure;

FIG. 1C is a cross-sectional view of a specific portion of the valve along plane A-A from FIG. 1B illustrating another aspect of the present disclosure;

FIG. 2 is a schematic view describing a magnetic pole effect that maintains the valve in an open condition according to one aspect of the present disclosure;

FIG. 3 is a cross-sectional view along plane A-A of the valve from FIG. 1A according to another embodiment of the present disclosure; and

FIG. 4 is a graphical representation of the effect that temperature has on the magnetic properties exhibited by a permanent magnet.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

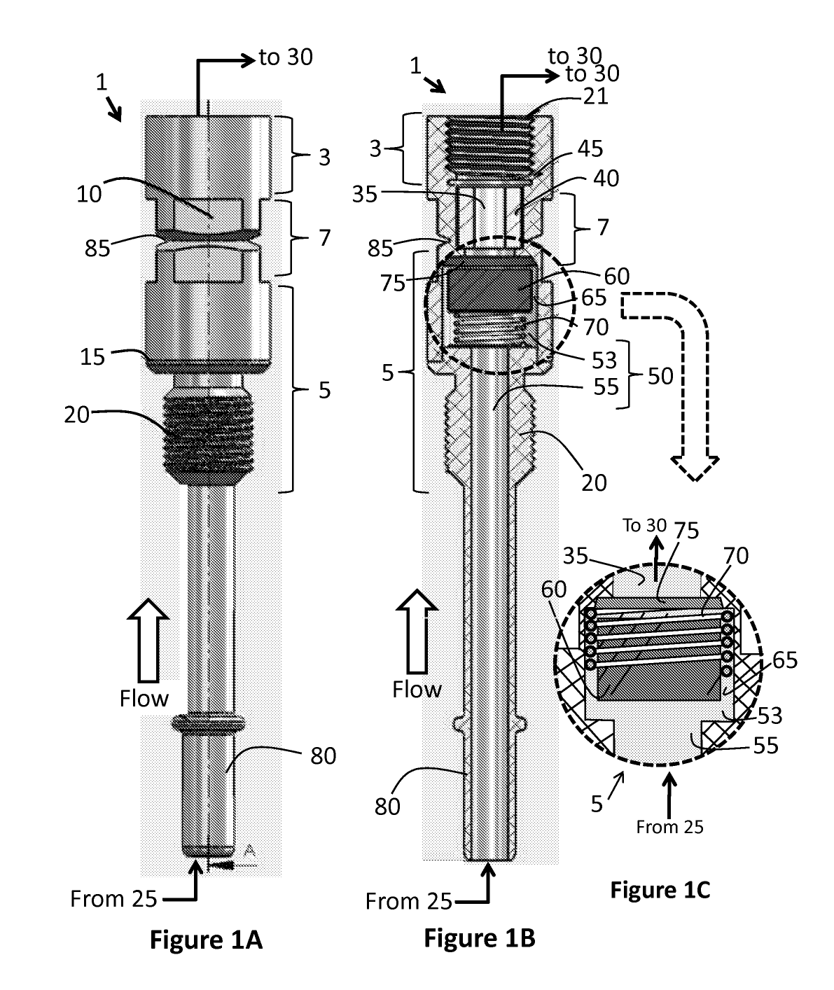

Referring to FIG. 1A, the safety valve 1 generally includes a valve body having a first region 3, a second region 5, and a separation region 7. The separation region 7 is designed such that the application of an internal or external action or force will cause the valve 1 to rupture. In other words, the separation region 7 has a predetermined area that will rupture when exposed to the internal or external force, thereby, allowing the first region 3 and second region 5 to at least partially separate. The first and second regions 3, 5 may have a variety of features, including but not limited to wrenching flats 10, welds 15, installation threads 20, and grooves for use with a c-clip or the like. Preferably, the wrenching flats 10 will encompass the separation region 7 in order that the application of torque necessary for the installation, maintenance, or removal of the safety valve 1 is not construed as an external force that will cause the valve 1 to rupture. The second region 5 is preferably connected to a fluid reservoir or supply line 25 through a pipe or conduit (e.g., fuel line) 80, while the first section 3 is connected to a fluid receiver 30 through another section of the pipe or conduit 80. During operation, the fluid is allowed to flow from the reservoir 25 (supply side) to the receiver 30.

Referring now to FIG. 1B, according to one embodiment of the present disclosure, the first region 3 of the valve body comprises a passageway or channel 35 that is part of the conduit 80 through which the fluid flows. The first region 3 also includes a first permanent magnet 40. This first permanent or top magnet 40 is preferably hollow in that it includes a passageway or channel 35. The interior surface of this passageway 35 becomes part of the conduit 80 through which fluid may flow. The first permanent magnet 40 may be held in place by a retaining clip 45, press-fit into the channel 35 in the first region 3, or held stationary by any other means known to one skilled-in-the-art.

Still referring to FIG. 1B, the second region 5 of the valve body 1 includes a channel 50 that is also part of the conduit 80 through which fluid may flow. This channel 50 may include top 53 and bottom 55 sections. The top section 53 of the channel 50 is wider than the bottom section 55. The second region 5 also includes a second permanent or sealing magnet 60 sized to fit into the top section 53 of the channel 50 and to form a gap 65 with the internal surface of the channel 50. Fluid may flow around the periphery of the sealing magnet 60 through the established gap 65.

The top section 53 of the channel 50 also includes a spring 70 and an annular seat 75 that acts as a sealing surface. The annular seat 75 is sized to mate with the top peripheral surface of the sealing magnet 60. The spring 70 being located such that it is in contact with the bottom surface of the magnet 60 and the bottom surface of the top section 53 of the channel 50.

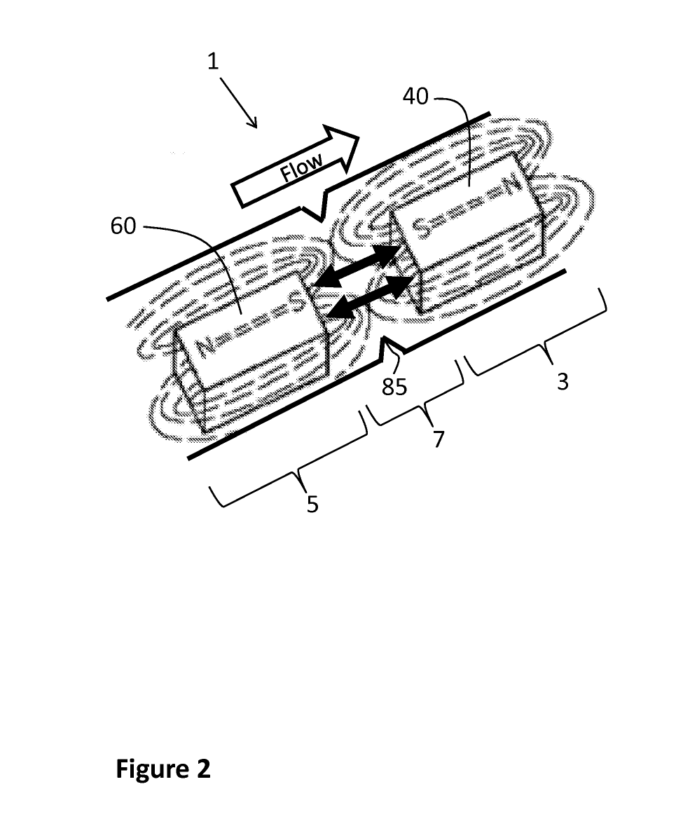

The first magnet 40 in the first region 3 and the second magnet 60 in the second region 5 are positioned such that their like poles interact with one another establishing a magnetic force. In the Example shown in FIG. 2, the first 40 and second 60 magnets are aligned so that their magnetic poles are facing one another and therefore repel one another. The magnetic repulsion force between the poles needs to be large enough to cause the spring 70 in the second region 5 in FIG. 1B to compress, allowing the second magnet 60 and the annular seat 75 in the top section 3 of the channel 53 to be separated from one another. Preferably, the spring is made of a material that is not magnetically permeable or polarizable in order to simplify the ability of the sealing magnet 60 to compress the spring. One skilled-in-the-art will understand that one could position the magnets such that they attract one another without exceeding the scope of the present provided the sealing magnet, spring, and annular seat are positioned such that the magnetic attraction force will allow the magnet and seat to separate in order for the fluid to flow.

Although FIG. 1B shows the sealing magnet 60 in a position that causes the spring 70 to undergo compression in order for the fluid to flow through the established channel 35, one skilled in the art will understand that in some applications it may be desirable to cause the spring 70 to undergo extension rather than compression. One such application is when the spring 70 exhibits some degree of magnetic permeability or polarizability.

Referring now to FIG. 1 C, one example of a valve 1 using a spring 70 that undergoes extension rather than compression is described. In this example, the spring 70 in the second region 5 of the safety valve 1 is sized such that its diameter is larger than the annular seat 75. In this manner, the spring 70 makes contact with the valve body and is supported there from. The sealing magnet 60 is sized to fit within the diameter of the spring 70. The magnet 60 makes contact with and is held by the spring 70 by any means known to one skilled in the art including press fitting, among others. The placement of the spring 70 and magnet 60 combination is predetermined so that the magnet 60 makes contact and mate with the annular seat 75.

Still referring to FIG. 1C, the magnetic repulsion force that occurs between the magnets 40 (see FIG. 1B) and 60 cause the spring 70 to undergo extension. Upon undergoing such extension, the spring assists the magnetic repulsion force in forcing the magnet 60 to separate from the annular seat 75, thereby, establishing a gap 65 through which a fluid may flow through the channel 35. When the valve 1 ruptures in the separation region 7, the magnetic repulsion force is removed and the magnet 60 and spring 70 will return to the position in which the magnet 60 mates with the annular seat 75 in order to stop the flow of fluid through the channel 35.

Referring once again to FIG. 1B, during normal operation the valve 1 is continuously held open such that fluid may flow from the reservoir 25 to the receiver 30. In other words, during normal operation of the valve 1, fluid is allowed to flow from the reservoir 25 through the conduit 80, into the lower section 55 of the channel 50 in the second region 5 of the valve 1, into the top section 53 of the channel 50 in the second region 5 of the valve 1, through the gap 65 established between the periphery of the second magnet 60 and the internal surface of the channel 50, through the space created between the second magnet 60 and the annular gap 65 by the repulsive forces between the first 40 and second 60 magnets, into the passageway 35 established in the first magnet 40, through the first region 3 of the valve 5 to the receiver 30.

The separation region 7, which is located in the valve body 1 between the first 40 and second 60 magnets, is designed to rupture due to the application of an internal or external force. Such an internal or external force, may include but not be limited to, a shearing force, a stretching force, a compressive force, a thermal change (e.g., increase/decrease in temperature), or a chemical degradation or attack that alters or weakens the material properties exhibited by separation region 7. Upon rupturing of the valve 1 in the predetermined area 85 of the separation region 7, the first region 3 and the second region 5 of the valve 1 may partially or fully separate from one another.

Upon the separation of the second 5 and first 3 regions, the magnetic repulsive force between the magnets 40, 60 is at least partially reduced so that the force exerted by the spring 70 on the second magnet 60 is larger than said magnetic repulsive force. The spring 70 forces the second magnet 60 to mate with the annular seat 75, thereby, eliminating the space between the magnet 60 and the seat 75 through which fluid can flow. Thus the flow of fluid from the reservoir 25 through the second region 5 of the valve 1 is stopped. The fluid present in the conduit 80 between the receiver 30 and the first region 3 of the valve 1 may leak from the conduit 80 to the surrounding environment after the valve is ruptured through the channel in the first region 3 of the valve 1. Typically, this will not be an issue when the fluid is not hazardous or there is only a small length of conduit 80 between the receiver 30 and the first region 3 of the valve 1.

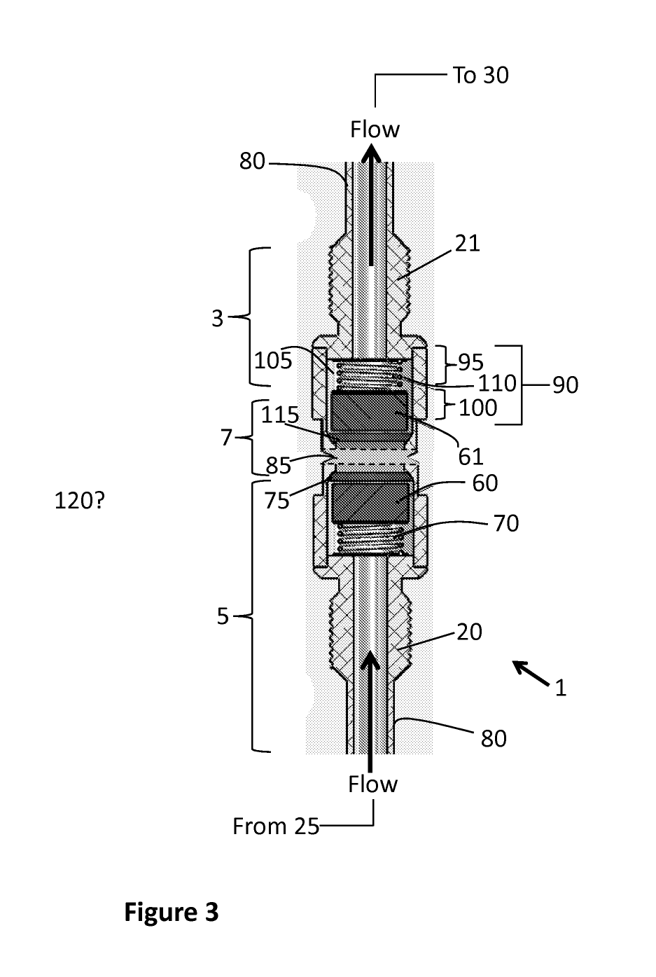

According to another aspect of the present disclosure, fluid can be prevented from leaking from the conduit 80 located between the receiver 30 and the first region 3 of the valve 1 after the valve is ruptured. Since leakage from the conduit 80 is eliminated in this embodiment, the length or size of conduit 80 located between the receiver 30 and the first region 3 of the valve 1 can be any length limited only by the parameters associated with the intended application. Referring now to FIG. 3, the safety valve 1 may include a second region 5 and separation region 7 as previously described. However, in this embodiment the first region 3 of the valve 1 is designed similarly to the second region 5 of the valve 1. For example, the first region 3 of the valve body 1 may include a channel 90 that is part of the conduit 80 through which fluid may flow. This channel 90 may include a top 95 section and a bottom 100 section. The bottom section 100 of the channel 90 being wider than the top section 95. The first region 3 also includes a first permanent magnet 40 sized to fit into the bottom section 100 of the channel 90 and to form a gap 105 with the internal surface of the channel 90. Fluid may flow around the periphery of the solid magnet 40 through the established gap 105. The bottom section 100 of the channel 90 also includes a spring 110 and an annular seat 115. The annular seat 115 is sized to mate with the bottom peripheral surface of the first magnet 40. The spring 110 being located such that it is in contact with the top surface of the magnet 40 and the top surface of the bottom section 100 of the channel 90.

Still referring to FIG. 3, the first magnet 40 in the first region 3 and the second magnet 60 in the second region 5 are positioned such that their like poles are facing one another and repel one another. The magnetic repulsion force between the poles is large enough to cause the spring 70 in the second region 5 and the spring 110 in the first region 3 to move either in compression or extension, allowing the first and second magnets 40, 60 to form a gap 120 between the annular seats 75, 115 present in the second and first regions 3, 5 of the valve 1. Thus during normal operation the valve 1 is continuously held open such that fluid may flow from the reservoir 25 to the receiver 30. Upon the rupturing of the valve 1 in the predetermined separation region 85 by an internal or external force (e.g., a shearing force, a stretching force, a compressive force, heat, or chemical degradation), the first region 3 and the second region 5 of the valve 1 may partially or fully separate from one another. Upon the separation of the second and first regions 3, 5, the magnetic repulsive force between the magnets 40, 60 is at least partially reduced so that the force exerted by the springs 70, 110 on the first and second magnets 40, 60 is larger than the magnetic repulsive force between the magnets 40, 60.

In this scenario, the spring 70 in the second region 5 forces the second magnet 60 to mate with the annular seat 75 in the second region 5, thereby, stopping fluid from flowing from the reservoir 25 through the conduit 80 and the second region 5 of the valve 1. Similarly, the spring 110 in the first region 3 forces the first magnet 40 to mate with the annular seat 115 in the first region 3, thereby, stopping fluid from leaking from the conduit 80 between the receiver 30 and the first region 3 of the valve 1.

The first and second magnets 40, 60 located in the first and second regions 3, 5 of the valve 1 may be any type of magnetic material that retains its magnetic properties after being removed from a magnetic field that is known to one skilled-in-the-art. Examples of such permanent magnetic materials may, include but not be limited to, Rare Earth magnets, ceramic magnets, flexible magnets, and Alnico magnets. Rare Earth magnets may include Neodymium Iron Boron (e.g., Nd₂Fe₁₄B, often abbreviated to NdFeB) and Samarium Cobalt (e.g., Sm₁Co₅ and Sm₂Co₁₇) magnets. Ceramic magnets may include those known as doped ferrite magnets (e.g., BaFe₂O₃ or SrFe₂O₃). A flexible magnet is a special type of ceramic magnet in which the ceramic magnet powder is bonded in a flexible binder. Alnico magnets represent a class of magnets that include aluminum, nickel, and cobalt in its composition.

The magnets may optionally be coated with a material that is capable of protecting the magnets from the chemical or physical effects of the fluid flowing through the valve. Examples of such protective materials or coatings may, include but not be limited to, vacuum deposited aluminum chromate, cadmium chromate, and other inorganic materials, as well as fluoropolymers (e.g., Teflon®, Viton®, etc.) and other organic coatings. The protective material or coating is preferably selected to be resistant to the chemical nature of the fluid flowing through the valve.

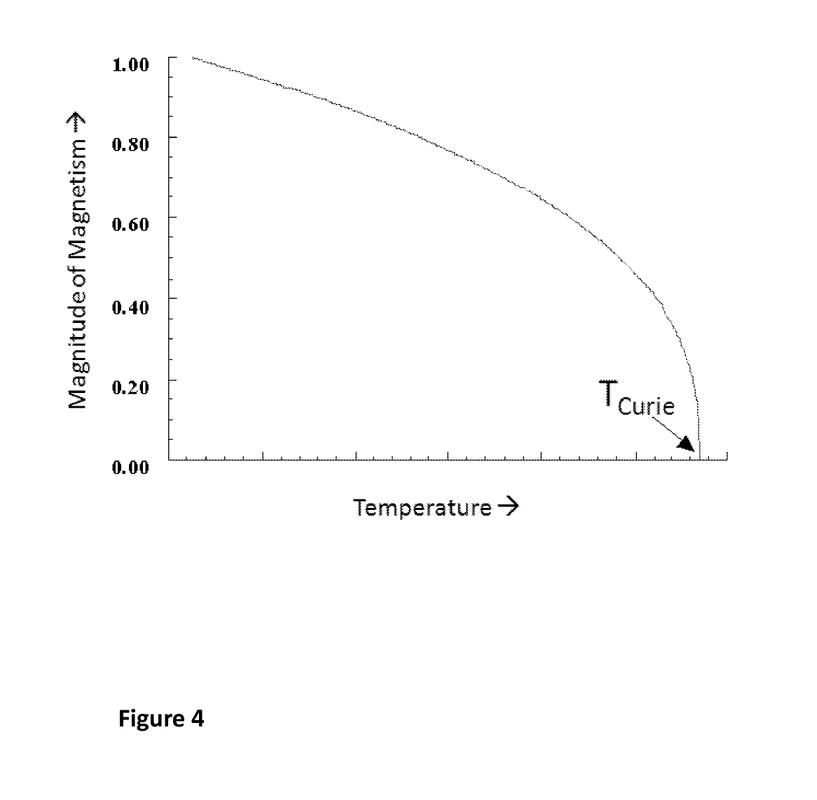

According to another aspect of the present disclosure, the composition may be selected based upon its useful operating temperature range. Referring to FIG. 4, the magnetic properties exhibited by a magnet become smaller as the temperature to which the magnet is routinely exposed increases. A critical temperature (e.g., Currie temperature) exists at which the elementary magnetic moments in the magnet become randomized and the material is demagnetized. According to one aspect of the present disclosure, at least one of the first and second magnets 40, 60 in the safety valve may have a maximum operating temperature of about 150° C. In this case, the occurrence of a fire the vicinity of the magnets may cause the magnetic repulsive force between the magnets decrease to a point where the spring will cause the magnet to mate with the annular seat and stop of the flow of fluid through the conduit. The Currie temperature and maximum operating temperature for various magnetic materials is provided in Table 1.

The valve body 1 may be made from any material known to one-skilled-in-the art to be compatible with the fluid flowing through the conduit 80. Examples of such materials include but are not limited to aluminum, brass, stainless steel, ceramics, and thermoplastic resins. The separation region 7 of the valve body 1 may be made completely or partially from a material that is different in composition (i.e., difference in alloy, etc.) than the material used in the first 3 and second 5 regions of the valve body 1. The material used in making the separation region 7 of the valve body 1 may be selected based upon any material property determined to be useful in ensuring that the rupturing of the valve 1 will occur in the separation region 7. Several examples of such material properties include elastic modulus, Poisson's ratio, shear modulus, mass density, tensile strength, compressive strength, and thermal expansion coefficient, among others. In addition, if desired, the wall thickness of the separation region 7 may be less than the wall thickness of the first 3 or second 5 regions of the valve body 1. The separation region 7 may also optionally include indentations or other features designed to initiate rupturing upon the application of an internal or external force.

Another objective of the present disclosure is to provide a method of stopping the flow of fluid through a conduit or pipe 80 when an internal or external force causes the pipe or conduit 80 to rupture at the predetermined separation region of the safety valve 1. The fluid flowing from the reservoir 25 through the conduit 80 and safety valve 1 to the receiver 30 may be any flammable, toxic, corrosive, or combustible liquid or gas. The receiver 30 may be an engine, motor, tank, reservoir, fuel transfer system, nozzle, shut-off valve, or another pipe or conduit. For example, fuel from a fuel supply tank may flow through a fuel line through the safety valve to a fuel transfer device. In this case, the safety valve is designed to be mounted or coupled to the vehicle. The occurrence of an external force, such as a collision or roll-over of the vehicle, may cause the safety valve to rupture in the separation region of the valve. Upon such rupturing, the fuel flowing from the supply side (i.e., from the fuel supply tank through the fuel line) is stopped by the magnet being forced to mate with the seat in the second region 5 of the safety valve 1, while fuel in the conduit between the first region 3 of the safety valve 1 and the fuel transfer device may also optionally be stopped from leaking.

The safety valve 1 may also optionally include an on-off valve junction reversibly coupled to the first 3 and/or second 5 regions of the valve 1. The on-off junction (not shown) may be coupled to the first region 3 or second region 5 of the valve body 1 through the use of any means known to one skilled-in-the-art, including but not limited to screw threads 20, 21, quick disconnects, or clamps. The intention of an on-off junction is to provide a means through which the first region 3 or the second region 5 of the valve 1 can be removed from the conduit 80 after the separation region 7 of the valve 1 has ruptured. For example, an operator may manually or electronically cause an on-off valve junction in communication with the second region 5 of the valve to close and an on-off valve junction in communication with the first region 3 of the valve 1 to close, thereby, allowing the operator to remove the first and second regions 3, 5 of the valve 1 from the corresponding conduit 80 without any leakage of fluid being encountered. A new safety valve 1 may then be placed in line, coupled to the on-off valves such that when the on-off valves are opened, the fluid flows from the second region 5 through the separation region 7 and the first region 3 of the safety valve 1. The on-off valve junctions may comprise any valve type known to one skilled-in-the-art including such examples as ball valves, butterfly valves, check valves, and gate valves, among others.

TABLE 1
Temperature given as degree Celsius (degree Fahrenheit)

| Material | T_{Curie} | Tₘₐₓ* |
|---|---|---|
| Neodymium Iron Boron | 310 (590) | 150 (302) |
| Samarium Cobalt | 750 (1382) | 300 (572) |
| Alnico | 860 (1580) | 540 (1004) |
| Ferrite | 460 (860) | 300 (572) |

The use of the safety valve is also anticipated to be useful for the flow of non-hazardous liquids (e.g., water, etc.) and gases (e.g., air, etc.) in situations where it is desirable to stop the flow of the liquid or gas from a supply line or reservoir. The safety valve may be used in systems to stop the flow of non-hazardous liquids and gases upon rupturing of the valve without exceeding the scope of the present disclosure.

A person skilled in the art will recognize that the measurements described are standard measurements that can be obtained by a variety of different test methods. The test methods described in the examples represents only one available method to obtain each of the required measurements.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled. Additional information describing one of the embodiments of the present disclosure is provided as Attachment A to this disclosure, the entire contents of which are, hereby, incorporated in their entirety by reference.

1. A safety valve designed to stop the flow of a fluid through a conduit or pipe when an internal or external force causes the valve to rupture, the safety valve comprising:
a valve body forming a channel through which the fluid may flow; the valve body having;
a first region and a second region, the first region including a first magnet within the channel, the first magnet configured to allow the fluid to flow through the channel and across the first magnet;
the second region including a second magnet configured to fit into the channel and to allow the fluid to flow through the channel and across the second magnet, a spring in engagement with the second magnet and the valve body, and an annular seat; the annular seat being part of the channel and configured to open and close with motion of the second magnet;
a separation region between the first region and the second region, the separation region designed such that the valve body may rupture at the separation region upon the application of the internal or external force;
wherein the first magnet and the second magnet are positioned so that their poles interact with a magnetic force having a magnitude that opposes a force of the spring thereby allowing the fluid to flow through the channel from the second region to the first region;
wherein when the valve ruptures at the separation region, the magnetic force acting between the first and the second magnets is reduced allowing the spring to cause the second magnet to close with the annular seat, thereby, stopping the flow of the fluid through the channel.

2. The valve of claim 1 wherein at least one of the first and the second magnets are coated with a material capable of protecting the the at least one magnet from the effects of the fluid flowing through the valve.

3. The valve of claim 1, wherein the of the spring force is produced by compression or extension of the spring.

4. The valve of claim 1 further comprising
the first region, having a first spring in contact coupled with the first magnet and the valve body, and a first annular seat; the first seat being part of the channel and configured to allow the fluid to flow through the channel and across the first magnet;
the second region spring forming a second spring and the second region annular seat forming a second annular seat wherein, upon rupture of the valve, the first magnet causes the first annular seat to close and the second magnet causes the second annular seat to close.

5. (canceled)

6. The valve of claim 1, wherein the fluid that flows through the valve is one selected from a, flammable, a toxic, a non-hazardous, a corrosive, or a combustible, liquid or gas.

7. The valve of claim 1, wherein the fluid is a fuel used to operate a combustion engine.

8. The valve of claim 1, wherein the fluid is water or air.

9. The valve of claim 4 wherein the first and the second magnets are coated with a material capable of protecting the magnets from the effects of the fluid flowing through the valve.

10. The valve of claim 1, wherein the external or internal force that causes the separation region to rupture is one selected from the group of a shearing force, a stretching force, a compressive force, a thermal change, and chemical degradation.

11. The valve of claim 1, wherein the Currie point at which at least one of the first and the second magnets partially loses its magnetism is greater than about 150° C.

12. The valve of claim 1, wherein the valve body is made from a material selected from the group of aluminum, brass, stainless steel, ceramics, and a thermoplastic resin.

13. The valve of claim 12, wherein the separation region of the valve body is at least partially made from a material that is different than the first and second regions of the valve body.

14. The valve of claim 1, wherein the magnetic force established through the interaction of the first and second magnets is a magnetic repulsion force.

15. A system for transferring a fluid provided with a safety mechanism that will stop the flow of the fluid through the system when an internal or external force causes a portion of the system to rupture; the system comprising:
a fluid supply;
a fluid receiver;
a conduit through which the fluid flows from the fluid supply to the fluid receiver; and
a safety valve coupled to the conduit so that the fluid flows through the safety valve; the safety valve having a valve body that forms a channel through which the fluid may flow; the valve body having:
a first region, the first region including a first magnet; the first magnet within the channel and configured to allow the fluid to flow through the channel and across the first magnet;
a second region, the second region including a second magnet within the channel and configured to allow the fluid to flow through the channel and across the second magnet, a spring in engagement with the second magnet and the valve body, and an annular seat; the annular seat being part of the channel and sized configured to open or close with movement of the second magnet; and
a separation region between the first region and the second region, the separation region designed such that the valve body may rupture at the separation region upon the application of the internal or external force;
wherein the first magnet and the second magnet are positioned so that their poles interact with a magnetic force having a magnitude that opposes a force of the spring, thereby allowing the fluid to freely flow through the channel from the second region to the first region;
wherein when the internal or external force causes the safety valve to rupture at the separation region, the second magnet moves to close the annular seat wherein the fluid flowing through the conduit is stopped.

16. A system for transferring a fluid in accordance with claim 15 further comprising
the first region having a first spring in contact with the first magnet and the valve body, and a first annular seat; the first annular seat being part of the channel and configured to open and close with movement of the first magnet;
the second region including the spring in the form of a second spring in contact with the second magnet and the valve body, and the seat in the form of a second annular seat wherein, upon rupture of the valve, the first magnet moves to close flow of the fluid through the first annular seat and the second magnet moves to close flow of the fluid through the second seat.

17. The system of claim 15, wherein the fluid receiver is one selected from the group of an engine, a motor, a tank, a reservoir, a fuel transfer system, a nozzle, a shut-off valve, and another pipe or conduit.

18. The system of claim 15, wherein the fluid being transferred is one selected from the group of a flammable, a toxic, a corrosive, or a combustible liquid and gas.

19. The system of claim 15, wherein the fluid being transferred is a non-hazardous liquid or gas.

20. The system of claim 18, wherein the fluid is a fuel used to operate a combustion engine.

21. The system of claim 19, wherein the fluid being transferred is water or air.

22. (canceled)

23. (canceled)

24. The system of claim 15, wherein the first magnet in the first region forms an internal a passageway, the passageway being part of the channel.

25. The system of claim 15, wherein the first magnet is sized to fit into the channel and to allow fluid to flow around its periphery; the first region further comprising a first spring that is in contact with the first magnet and the valve body, and a first annular seat; the first seat being part of the channel and sized to mate with the first magnet, the spring in the form of a second spring and the annular seat in the form of a second annular seat;
wherein the interaction between the poles of the first magnet and the second magnet causes the first spring in the first region to move, thereby, allowing fuel to freely flow through the channel.

26. The system of claim 15, wherein the liquid fuel is used to operate a combustion engine.

27. The system of claim 15, wherein the external force is one selected from the group of a shearing force, a stretching force, a compressive force, and a thermal change.

28. The method of claim 15, wherein the fuel flows from a fuel tank or reservoir through the pipe or conduit to a fuel transfer device or nozzle.
